(19) United States
(12) Patent Application Publication
(10) Pub. No.: US 2022/0267534 A1
(43) Pub. Date: Aug. 25, 2022

(54) HYDROPHILIC SILICONE MADE OF OLEFINIC UNSATURATED POLYOXYALKYLENE GLYCIDYL ETHER, ITS COMPOSITION AND PREPARATION METHOD THEREOF

(71) Applicant: WACKER METROARK CHEMICALS PVT. LTD., Kolkata (IN)

(72) Inventors: Sougata BHATTACHARYA, Kolkata (IN); Sunanda BISWAS, Kolkata (IN)

(21) Appl. No.: 17/622,909

(22) PCT Filed: Jun. 26, 2020
(86) PCT No.: PCT/IB2020/056048

§ 371 Date: Dec. 27, 2021

(30) Foreign Application Priority Data
Jun. 27, 2019 (IN) 201931025732

(51) Int. Cl. C08G 77/388; D06M 15/643; D06M 15/647; C08G 77/46; B01J 23/42

(52) U.S. Cl. CPC C08G 77/388; D06M 15/6436; D06M 15/647; D06M 2200/50; B01J 23/42; D06M 2200/12; C08G 77/46

(57) ABSTRACT

Present invention is related to a hydrophilic silicone polymer prepared by using an olefinic unsaturated polyoxyalkylene epoxy compound. An amine compound having at least one tertiary amine group which may be further reacted with the polyoxyalkylene epoxy siloxane molecule is used further for preparing such hydrophilic ABA molecule for improving both the feel and hydrophilicity in any natural or artificial fiber, thus solving the most challenging problem of balancing i.e. improving both hydrophilicity and feel property in the field of fabric or fiber treatment. The present invention also relates to the process of preparation of the said hydrophilic silicone polymer and its emulsion.

### FIELD OF INVENTION

Increase of hydrophilicity and improving the feel property, has been the most challenging problem in the field of fabric or fiber treatment. Present invention is related to a hydrophilic silicone polymer and its emulsion made of an olefinic unsaturated polyoxyalkylene epoxy compound for improving the feel and hydrophilicity simultaneously in any natural or artificial fiber. The present invention also relates to the process of preparation of the said hydrophilic silicone polymer and its emulsion. An amine compound having at least one tertiary amine group which reacted with the polyoxyalkylene epoxy siloxane molecule is used further for preparing such hydrophilic ABA molecule for improving both the feel and hydrophilicity in any natural or artificial fiber, thus solving the most challenging problem of balancing i.e. improving both hydrophilicity and feel property in the field of fabric or fiber treatment. The present invention also relates to the process of preparation of the said hydrophilic silicone polymer of ABA type and its emulsion.

### BACKGROUND

Synthetically produced fibers (such as polyester, polyamide or polyolefin fibers or their blends) are often so hydrophobic that no water or no perspiration can be absorbed. Even natural fiber treated with amino-silicone, loose hydrophilicity after finishing since it forms a hydrophobic silicone film on textile surface. It is also observed that fabric of natural fiber also become very hydrophobic due to change of OH group orientation in cellulose after mercerization. These all ultimately develop uncomfortable properties in the textile finishing. This very unpleasant property for the wearer of such textiles can be eliminated by treatment of the textile fibers or of the textiles with the textile softener. The textiles are rendered hydrophilic thereby; perspiration can be absorbed and simultaneously improve comfort level significantly. Furthermore, the textiles treated with hydrophilic softener acquire a pleasant soft handle.

In the prior art DE102007015372 or US2008261473 which define a polysiloxane and textile auxillary, the kind of reaction that was tried is to link the polyether group with the Si—H molecule and then the reaction of the glycedyl chloride (or epichlorohydrin) in presence of transition metal halogen (e.g. SnCl₄) catalyst for dehalogenation reaction. Such kind of reaction actually takes place by opening the epoxy ring while reacting with the —OH group and thus forming the chloro derivative of the ring opened epichlorohydrin as such reaction is correctly depicted in column 6, line 45 to 55 of U.S. Pat. No. 5,098,979. Again even small presence of such tin catalyst may further degrade the final polymer and the desired effect may not be reached. Again, here in the example para [0026] the 0.1 moles of tertiary amine is used for 0.2 moles of the epoxy groups of the siloxane, is metered in, making the quaternary group compound where only 50% of epoxy group is opened to link with the tertiary amine group to form quaternary amine function and 50% of the epoxy group remains unreacted. This is also in line with the claim filed where it says that “each molecule containing at least one epoxy radical —PY and one -MZ radical”. This type of molecule do not give the most appropriate hand feel along with the desired hydrophilicity, since here the molecule will have quaternary group only at one end and will bind only at one end with the textile, whereas the other end of the molecule will have the epoxy group and will contribute in hydrophilicity but will decrease the hand feel since the siloxane chain of the molecule will be shielded by the terminal epoxy group present on the free end the molecule.

U.S. Pat. Nos. 5,981,681 and 5,807,956 describes non-hydrolyzable, block, (AB)ₙ A type, copolymers comprising alternating units of polysiloxane and amino-polyalkyleneoxide and provides a method for the preparation of these copolymers. Also provided is the use of these copolymers as softeners, in particular durable, hydrophilic textile softeners, which improve tactile properties of the textiles substrates treated with the commercial soil release finishes. Such compositions are having high molecular weight polymers that will create emulsion destabilization during processing of the textiles in the industry.

In EP2780396 (B1) invention relates to a linear block ABA silicone polyalkyleneoxide copolymer comprising internal silicone units and further comprising polyalkyleneoxide units wherein the copolymer is capped with the polyalkyleneoxide units, where the molecule is terminated by R⁵ is of the formula (CₙH₂ₙ₊₁)— with n=1-30. Such terminal alkyl group can only be used for lipophilic kind of surface (e.g. hair) but in textile this molecule do not show any desired effect since this molecule may not properly bind with the textile and therefore can't be used for the hydrophilic like of material (e.g. textile).

Again there are U.S. Pat. No. 6,242,554, where there on one end there is a polyether group and the other end has quaternium group, such molecule gives moderate hydrophilicity and moderate hand feel.

In US2004219371A1, here the polyether radical R³ recide in the branch or terminal of the polysiloxane of the general formula (I) of the claim, such molecule is structurally different and do not show the high amount of hydrophilicity when applied on the textile.

In US2019119450A1, the ABA type of a hydrophilic silicone polymer for improving and balancing the feel and hydrophilicity of natural or artificial fibers. There is a need for further improvement of a pleasant soft handle with improved water absorption property on the textile along with color fastness for chlorine water treatment.

Though there are many prior art attempts, but the balance between the hand feel and hydrophilicity is a desirable property.

This is the usual phenomenon that the hydrophilicity decreases with the increase in hand feel property and vice versa, since hydrophilicity property comes from the hydrophilic part of the molecule and hand feel comes from the hydrophobic part of the molecule. So, till now in the prior art we see those molecules that usually have a balance of both the properties and both of these properties are usually optimised to get both the properties at a manageable range. The new hydrophilic molecule has surprisingly improved property of hydrophilicity without usual decrease in the hand feel properties. Most surprisingly the hand feel property improves with the improve in hydrophilicy. Such phenomenon is surprising as the hand feel is mainly due to the long silicone chain, and such silicone chain is considered as water repelling and hence moves away from the property of hydrophilicity. But this molecule is surprisingly having an improved hydrophilicity with the improved hand feel.

The new hydrophilic molecule or in the form of other compositions and the emulsion thereof can be any hard surface which needed the high hydrophilicity along with the improved feel properties, specially when the natural or artificial fibres is treated with new hydrophilic molecule, that are usually in the woven or non woven form render improved desired properties.

Also, the molecules of the prior art having an amino group will induce yellowness on thermal treatment during the treatment process. Surprisingly the new hydrophilic molecule or its composition does not show any yellowness on even high thermal treatment.

### Objective of Invention

The objective of invention is to have a treatment composition with improved hydrophilicity along with improved hand feel. It is thus an object of the invention to present a new hydrophilic silicone molecule that is suitable as hydrophilic softeners for textiles. The textiles are rendered hydrophilic thereby, and furthermore the textiles acquire a pleasant soft handle with improved water absorption property on the textile.

### SUMMARY OF THE INVENTION

According to the basic aspect of the present invention, it is to provide the hydrophilic silicone polymer of structure (I), that is suitable as a suitable hydrophilic softener primarily for but not restricted to textile application. A silicone polymer having structure (I)

XABA′X′ (I)

wherein, B is a siloxane hydrophobic part comprising (OSi(R)(R′))ₓ group,
A and A′ are hydrophilic part comprising (CH₂)ₓ(OR¹)_{y}G group, and
X and X′ are ionic group attached with the hydrophilic part,
R and R′ are same or different and are a hydrogen atom or a C₁ to C₁₀ alkyl group, or a C₁ to C₁₀ substituted alkyl group,

G is —R⁶(OR²)_{f}—O—R⁵CH(OH)—CH₂—,

R¹, R² is same or different and is a linear or branched C₁ to C₆ alkylene radical,
R⁵, R⁶ is same or different and is a linear or branched C₁ to C₆ alkylene radical or a cyclic C₃ to C₈ alkylene radical, x is from 20 to 500, y is from 5 to 30, z is from 1 to 20 and f is from 0 to 30. In one of the embodiments. the X and X′ are ionic group are cationic group.

Here, the cationic group having a structure (II)

—N⁺Z_{3-w}(R³—(OR⁴)_{g}—NZ¹ₕ)_{w} (II)

wherein, Z is a hydrogen atom or a C₁ to C₁₀ alkyl group, or a C₁ to C₁₀ substituted alkyl group, or a C₁ to C₁₀ alkyl group with terminal or branched hydroxyl group, or from C₃ to C₁₀ cyclic alkyl group, or any other group that has the positive electron donating effect on the lone pair of adjacent nitrogen atom,
Z¹ is Z or carbonyl or carboxyl or amide group, or any other group that has the electron withdrawing effect on the lone pair of adjacent nitrogen atom, R⁴ is same or different and is a C₁ to C₁₀ alkylene radical, R³ is same or different and is a C₁ to C₁₀ alkylene radical, g is 0 or an integer from 1 to 70, w is 0 or an integer from 1 to 2, h is an integer 2 or 3. In one of the embodiments, when h is 2 —NZ¹ is a non-ionic Nitrogen group and when h is 3 —NZ¹ is an ionic i.e. cationic Nitrogen group.

The silicone polymer having structure (I) is a hydrophilic silicone polymer. A composition comprising a silicone polymer of structure (I). In one embodiment, the composition is an aqueous composition comprising a silicone polymer of structure (I). In one embodiment, the aqueous composition is an aqueous emulsion. In a process for treating organic fibers with an aqueous composition, the improvement comprising treating with a silicone polymer of structure (I). The process for treating organic fibers, wherein the aqueous composition is an aqueous emulsion. The process for treating organic fibers, wherein the hydrophilicity, water-retention, blotchiness and softness of the organic fibers is improved relative to untreated organic fibers. The process, wherein the organic fiber is in the form of a textile fabric.

It was surprisingly found out that, the textile treated with the inventive composition gives specifically advantage of blotchiness or colour fastness with chlorinated water. The ISO 105-E03:2010 Textiles—tests for colour fastness—Part E03: colour fastness to chlorinated water (swimming-pool water) determines the high stability and colour fastness property.

In one embodiment, the silicone polymer, wherein the ionic group of the silicone having structure (I) is a cationic group.

In another embodiment, the silicone polymer, wherein the ionic group is an anionic group, or an amphoteric group.

The invention provides a process for preparing the hydrophilic silicone polymer comprising:

A process for preparing the silicone having structure (I) of claim 1 comprising:

(i) reacting in a first step
a hydrogen siloxane of the formula

HR′₂SiO(R₂SiO)ᵤ(RHSiO)ₙSiR′₂H (IV),

wherein R and R′ are same or different and are a hydrogen atom or a C₁ to C₁₀ alkyl group, or a C₁ to C₁₀ substituted alkyl group,
u is an integer from 1 to 500, n is 0 or an integer from 1 to 50,
with, an olefinic unsaturated polyoxyalkylene epoxy compound of the formula

CH₂═CH—R⁶—(OR²)_{y}—O—R⁵—CH(O)CH₂ (V),

wherein, R² is same or different and is a linear or branched C₁ to C₆ alkylene radical, in one of the embodiments C₂ and C₃ alkylene radical,
R⁵, R⁶ is same or different and is a linear or branched C₁ to C₆ alkylene radical or a cyclic C₃ to C₈ alkylene radical, y is from 1 to 30, and
in the presence of a catalyst comprising platinum or its compounds or complexes to form a polyoxyalkylene epoxy functional siloxane;
with the provision that the olefinic unsaturated polyoxyalkylene epoxy compound is used in an amount of from 0.2 to 1 mol, preferably from 0.8 to 1 mol, of the olefinic unsaturated radical (C═C) in the epoxy compound per 1 mol Si-bonded hydrogen in the hydrogen siloxane and optionally the olefinic unsaturated polyether is used in an amount of from 0 to 0.8 mol, preferably from 0 to 0.2 mol, of the olefinic unsaturated radical (C═C) in the polyether per 1 mol Si-bonded hydrogen in the hydrogen siloxane, (ii) reacting in a second step
the resulting polyoxyalkylene epoxy functional siloxane obtained from the first step with an amine compound of the formula (III)

NZ_{3-w}—(R³—(OR⁴)_{g}—NZ¹ₕ)_{w} (III)

wherein, Z is a hydrogen atom or a C₁ to C₁₀ alkyl group, or a C₁ to C₁₀ substituted alkyl group, or a C₁ to C₁₀ alkyl group with terminal or branched hydroxyl group, or from C₃ to C₁₀ cyclic alkyl group, or any other group that has the positive electron donating effect on the lone pair of adjacent nitrogen atom,
Z¹ is Z or carbonyl or carboxyl or amide group, or any other group that has the electron withdrawing effect on the lone pair of adjacent nitrogen atom, R⁴ is same or different and is a C₁ to C₁₀ alkylene radical, R³ is same or different and is a C₁ to C₁₀ alkylene radical, g is 0 or an integer from 1 to 70, w is 0 or an integer from 1 to 3, h is an integer 2 or 3.

A composition comprising a silicone polymer prepared by the said process. In one embodiment, the composition is an aqueous composition comprising a silicone polymer prepared by the said process.

### DETAILED DESCRIPTION

The viscosity of the hydrophilic silicone polymer fluid is preferably from 100 to 15000 mPa·s at 25° C. The amine value of the hydrophilic silicone polymer is preferably from 2 to 60 mg of KOH per gram of polymer.

In the first step of the process of the present invention more preferably the olefinic unsaturated polyether epoxy compound is used in an amount of from 1 mol of the olefinic unsaturated radical (C═C) in the polyether epoxy compound per 1 mol Si-bonded hydrogen in the hydrogen siloxane. In one of the non-limiting embodiments, the 0.9 to 1 mole of olefinic unsaturated polyether epoxy compound and optionally up to 0.1 moles of the olefinic unsaturated polyether is reacted in the first step either simultaneously or stepwise and either mixed together or dosed separately either at a predetermined rate or at a predetermined quantity at a predetermined interval.

A hydrogen silicone is commercially available from Wacker Chemie AG as Wacker H polymer 55, SilGel 600 etc.

The invention provides an aqueous composition comprising the hydrophilic silicone polymer fluid of the present invention, wherein the composition is an aqueous emulsion.

The invention provides a process for treating organic fibres with an aqueous composition comprising a hydrophilic silicone polymer of the present invention.

Preferably, the hydrophilic silicone polymer of the present invention is used as a hydrophilic softener.

In one of the embodiments, the hydrophilic softener which is hydrophilic silicone polymer fluid may be a selected from (a) a siloxane with one end terminated with polyether and other end terminated with polyoxyalkylene epoxy further reacted with amine compound or alkyl amine wherein the amine group is primary, secondary or tertiary, and preferably a tertiary amine group, (b) a siloxane with both ends terminated with polyoxyalkylene epoxy (i.e. α,ω-diepoxysiloxane) and further reacted with amine compound (or alkyl amine) wherein the amine group is primary, secondary or tertiary, and preferably a tertiary group and (c) a siloxane with both ends terminated with polyether, or its mixtures thereof. There may be unreacted Si—H polymer, polyoxyalkylene epoxy terminated siloxane, or unreacted tertiary amine compound.

The invention provides a process for treating organic fibres, wherein the aqueous composition is an aqueous emulsion. Preferably, the process for treating organic fibres improves the hydrophilicity and softness of the organic fibres. Preferably in the process, the organic fibre is a textile fabric.

In one of the embodiments, the amine value is determined by acid-base titration using a potentiometer [Make: Veego; Model: VPT-MG]. 0.6 g of sample is taken in a 500 ml beaker and toluene-butanol 1:1 mixture is added and stirred to mix the sample thoroughly and the sample solution is titrated with a 0.1(N) HCl solution. The amine value is calculated according to the formula (56.11×V×N)/W mg KOH/g of sample, where, V=Volume of HCl required in ml, N=Normality of HCl i.e. 0.1 N, W=Weight of the sample taken in gram.

In one aspect of the invention, the amine value of the hydrophilic silicone polymer is preferably between 2 and 60 mg of KOH per gram of polymer.

In one of the embodiments, the epoxy concentration of a polyoxyalkylene epoxy siloxane and the number of D units, i.e. number of —(OSi(CH₃)₂)— unit is determined by NMR data. Since, after reaction and rearrangement process, the Si—H polymer obtained is mainly a mixture of Si—H polymers, which is then further reacted with allyl polyoxyalkylene epoxy group and thus it is important to determine the epoxy concentration of the polymer mass to get the average epoxy concentration and from this value, the total number of moles of epoxy are considered. Then the amine compound is selected for further reaction in 1:1 ratio based on the epoxy concentration of the total polymer.

In the process of the present invention an olefinic unsaturated epoxy compound of the formula

CH₂═CH—R⁶—(OR²)_{y}—O—R⁵—CH(O)CH₂ (V)

is used, wherein R⁵, R⁶ is a linear C₁ to C₆ alkylene radical or a cyclic C₃ to C₈ alkylene radical and y is 0 or an integer from 1 to 30. The (O) group represents the bridge oxygen group linked to the two carbon atoms. The most preferable and suitable olefinic unsaturated polyether epoxy compound includes: CH₂═CH—(CH₂)—(OCH₂CH₂)ᵣ—(OCH(CH₃)CH₂)ₛ—O—CH₂—CH(O)CH₂, where r, s is 0 or from 1 to 30,

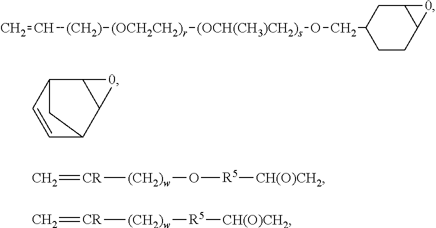

wherein R is a methyl radical.

In one of the embodiment, the olefinic unsaturated polyoxyalkylene epoxy compound is preferably allyl polyoxyethylene polyoxypropylene glycidyl ether [CH₂═CH—(CH₂)—(OCH₂CH₂)ᵣ—(OCH(CH₃)CH₂)ₛO—CH₂—CH(O)CH₂] where r=8,10, and s=0,1 available from JIANGSU ZHONGSHAN CHEMICAL CO. LTD. The olefinic unsaturated epoxy compound is preferably used in an amount of from 0.9 to 1 mol of the olefinic unsaturated radical (C═C) in the polyether epoxy compound per 1 mol Si-bonded hydrogen in the hydrogen siloxane.

Optional olefinic unsaturated polyether is preferably selected from polyethylene glycol allyl methyl ether CH₂═CHCH₂(OC₂H₄)ₙOH; CH₂═CHCH₂(OC₃H₆)ₙOH; polyalkylene glycol allyl methyl ether (EO/PO random) CH₂═CHCH₂O(C₂H₄O)ₗ(C₃H₆O)ₖH, here l and k are integers from 2 to 100, preferably from 20 to 40 and more preferably from 25 to 30. Non-limiting example of a preferred olefinic unsaturated polyether is allyloxy (polyethylene oxide) (EO 29) available as Polymeg 1200AP from IGL, India. The olefinic unsaturated polyether is preferably used in an amount of from 0 to 0.1 mol of the olefinic unsaturated radical (C═C) in the polyether per 1 mol Si-bonded hydrogen in the hydrogen siloxane.

The amine compound that contains at least 1 tertiary amine group is selected from but not limited to polyalkylaminoalkylamine, polyetheramine, fatty acid amido alkylyl dialkylamines etc. Polyalkylaminoalkylamine is selected from but not limited to Bis-(2-dimethylaminoethyl)ether, N,N-dimethylethanolamine, Benzyldimethylamine, N,N-dimethylcyclohexylamine, Pentamethyldiethylenetriamine, N,N,N′,N″,N″-pentamethyl-dipropylenetriamine, N,N-bis[3-(dimethylamino)propyl]formamide commonly available from Huntsman in the name of Jeffcat, dimethyl cyclohexyl amine. Fatty acid amidoalkyl dialkylamine is selected from but not limited to cocamidopropyl dimethyl amine, steryl amido propyl dimethyl amine, luramidopropyl dimethylamine, linoleamidopropyl dimethylamine, myristamidopropyl dimethylamine, oatamidopropyl dimethylamine etc.

The polyetheramine or polyoxyalkylene polyamine used contains polyoxyalkylene, capped with diamine in alpha omega position of the molecule or its mixture thereof. Carbon chain in alkylene part in alkylene ether may be C₂ to C₆, most preferably C₂ or C₃ or mixture. Polyoxyalkylene chain length may vary from 1 to 100, most preferably 5 to 40. The polytheramines commercially available are Jeffamine diamines include the D, ED, and EDR series products, Jeffamine T series products are triamines, the SD Series and ST Series products consist of secondary amine versions of the Jeffamine and alike from Huntsman or 4,7-dioxadecane-1,10-diamine; 4,9-dioxadecane-1,12-diamine; 4,7,10-trioxatridecane-1,13-diamine, polyetheramine D230, polyetheramine D400, polyetheramine D2000, polyetheramine T403 from BASF or its mixture thereof. The most preferable polyetheramine, used according to the present invention is a primary polyetherdiamine which a polyoxyalkylene capped with primary diamine in alpha omega position of the molecule or its mixture thereof. Most preferable non-limiting example polyetheramine is a polyoxypropylene capped with primary diamine in alpha omega position. Excess of greater than or equal to 20 mole percent of tertiary amine group to that of the polyoxyalkylene epoxy functional siloxane is used preferably during the preparation of the copolymers, and the majority of the terminal groups of the product are expected to be a tertiary amino group.

In the second step of the process of the present invention the amine compound is preferably used in an amount of equal or more than 1.2 mol amino group in the amine compound per 1 mol epoxy group in the polyoxyalkylene epoxy functional siloxane.

Preferably R is same or different and is a C₁ to C₂₀ alkyl radical. Examples of alkyl radicals R are the methyl, ethyl, n-propyl, isopropyl, 1-n-butyl, 2-n-butyl, isobutyl, tert-butyl, n-pentyl, isopentyl, neopentyl and tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radicals, decyl radicals, such as the n-decyl radical, dodecyl radicals, such as the n-dodecyl radical, and octadecyl radicals, such as the n-octadecyl radical. Preferably R is a methyl radical.

R¹, R² is a C₁ to C₆ polyalkylene oxide radical. Examples for C₁ to C₆ polyalkylene oxide radicals are polyethylene oxide radical, polypropylene oxide radical, polybutylene oxide radical, pentoxy radical, hexoxy radical or its isomers or its mixtures thereof. The alkyl substitution may be halo, hydroxy, carboxy, ether or ester substituted group. In the process for preparing the hydrophilic silicone polymer a solvent can be used.

The solvents used are generally non-reactive solvents. The preferable solvent used is 2-Ethyl-1-hexanol. It is possible that the epoxy end group on the polysiloxane can undergo side reactions with the solvent, water or alcohol to form the respective diol or ether alcohol.

The epoxycyclohexane is used to stop the back-donation reaction for the allyl functional molecules during hydrosilylation reaction using platinum catalyst.

In another aspect of the invention, the viscosity of the hydrophilic silicone polymer is at least 50 mPa·s at 25° C. and more preferably from 100 to 15000 mPa·s at 25° C. Viscosity is measured by Anton Paar Rheometer; model MCR101, geometry single gap cylinder: CC 27 spindle or cone plate of 60 mm diameter and 2° and shear rate 1 s⁻¹. The viscosity value is taken at 60 sec. measured at shear rate=1 s⁻¹, temperature of 25° C. The measurement is repeated thrice. MCR Rheometer Series products work as per USP (US Pharmacopeia Convention) 912—Rotational Rheometer methods.

The catalysts for the hydrosilylation reaction in the first step preferably comprise a metal from the group of the platinum metals, or a compound or a complex from the group of the platinum metals. Examples of such catalysts are metallic and finely divided platinum, which may be present on supports, such as silicon dioxide, aluminum oxide or activated carbon, compounds or complexes of platinum, such as platinum halides, e.g. PtCl₄, H₂PtCl₆*6H₂O, Na₂PtCl₄*4H₂O, platinum-olefin complexes, platinum-alcohol complexes, platinum-alkoxide complexes, platinum-ether complexes, platinum-aldehyde complexes, platinum-ketone complexes, including reaction products of H₂PtCl₆*6H₂O and cyclohexanone, platinum-vinylsiloxane complexes, such as platinum-1,3-divinyl-1,1,3,3-tetramethyl-disiloxane complexes with or without detectable inorganically bonded halogen, bis(gamma-picoline)platinum dichloride, trimethylenedipyridineplatinum dichloride, dicyclopentadieneplatinum dichloride, dimethylsulfoxideethyleneplatinum(II) dichloride, cyclooctadiene-platinum dichloride, norbornadiene-platinum dichloride, gamma-picoline-platinum dichloride, cyclopentadiene-platinum dichloride, and also reaction products of platinum tetrachloride with olefin and primary amine or secondary amine, or primary and secondary amine, such as the reaction product of platinum tetrachloride in solution in 1-octene with sec-butylamine, or ammonium-platinum complexes.

Preferably, the reaction is carried out in between 70 to 110° C., more preferably from 80 to 100° C., in the presence of a catalyst, preferably hexachloroplatinic acid, preferably in the range of 500 to 5000 ppm by weight. The reaction is preferably carried out in absence of oxygen, i.e. under N₂ atmosphere.

In another embodiment of the invention, the aqueous emulsion has a surfactant or emulsifier, which is chosen from anionic, cationic or non-ionic emulsifier, preferably cationic or non-ionic emulsifier or mixture thereof and most preferably non-ionic emulsifier or mixture of non-ionic emulsifiers.

According to another aspect of the present invention there is provided an aqueous composition comprising the hydrophilic silicone polymer of the present invention. Preferably the aqueous composition is an aqueous emulsion.

According to another aspect of the present invention there is provided a composition, preferably a concentrate composition, comprising the hydrophilic silicone polymer of the present invention. Preferably, the concentrate composition comprises the hydrophilic silicone polymer from 1 to 99 weight percent, more preferably from 50 to 99 weight percent, an emulsifier from 0.1 to 20 weight percent, more preferably from 5 to 20 weight percent, acetic acid or its derivatives from 0.1 to 10 weight percent, more preferably from 0.1 to 5 weight percent, and optionally a biocide, preferably as per the required permitted quantity, all based on the total weight of the composition.

In another aspect of the present invention water, preferably demineralized (DM) water, is added to the concentrate composition to obtain the aqueous composition comprising the hydrophilic silicone polymer.

Preferably, the aqueous composition comprises the hydrophilic silicone polymer of the present invention from 5 to 99 weight percent, more preferably from 5 to 70 weight percent, most preferably from 5 to 40 weight percent, an emulsifier from 0.1 to 20 weight percent, more preferably from 0.1 to 10 weight percent, acetic acid or its derivatives from 0.1 to 10 weight percent, more preferably from 0.1 to 10 weight percent, most preferably from 0.1 to 5 weight percent, and optionally a biocide, preferably as per the required permitted quantity, and water, wherein the amounts of water is adding up to 100 weight percent.

In one of the embodiments, in the emulsion, in acidic medium, the nitrogen atom of the amine compound having nitrogen end group in the hydrophilic silicone polymer group will obtain a positive valiancy to form N⁺, where, M⁻ is an anionic group, preferably an anion of a corresponding acid, such as a carboxylate anion, for example an acetate anion, to the N⁺ can be obtained.

Particularly suitable non-ionic emulsifiers include alkyl polyglycol ethers, alkylated fatty alcohol alkyl aryl polyglycol ethers, ethylene oxide/propylene oxide (EO/PO) block polymers, fatty acids, natural substances and their derivatives, such as lecithin, lanolin, saponins, cellulose; cellulose alkyl ethers and carboxyalkyl celluloses, saturated and unsaturated alkoxylated fatty amines. Preferable non-ionic emulsifier is an alkylated fatty alcohol a non-limiting example of alkylate fatty alcohol is polyoxyether of lauryl alcohol (CH₃(CH₂)₁₀CH₂OH).

The subject process for treating, i.e. impregnating, organic fibers is useful with all organic fibers, for example in the form of filaments, yarns or as textile fabrics such as webs, mats, strands, woven, loop-forming knitted or loop-drawlingly knitted textiles, as have hitherto been treatable with organosilicon compounds. Examples of fibers, which can be treated by the process according to the invention, are fibers composed of keratin, especially wool, polyvinyl alcohol, interpolymers of vinyl acetate, cotton, rayon, hemp, natural silk, polypropylene, polyethylene, polyester, polyurethane, polyamide, cellulose, and blends of at least two such fibers. As it is clear from the preceding enumeration, the fibers can be of any natural or synthetic origin. The textiles or textile fabrics can be present in the form of fabric webs or garments or parts of garments.

In one of the other elements, hydrophilicity of the hydrophilic silicone polymer composition is measured by water absorbency of fabrics coated with the hydrophilic silicone polymer composition measured according to test of Water Retention of Terry towel—ASTM D 4772-97 (Reapproved 2004). It can be used on textiles of any fiber content or construction, including woven, knit and nonwoven.

Water Retention of Terry towel—ASTM D 4772-97 (Reapproved 2004): This test method is used to test the surface water absorption of terry fabrics by water flow for bath towels, bath sheets, hand towels, kitchen towels, dishcloths, washcloths, beachwear, bathrobes and the like in percentage. This test method determines the ability of a terry fabric to rapidly absorb and retain liquid water from surfaces such as human skin, dishes, and furniture. The towel used for the experiment is white colored and having 370 GSM. Water retention of untreated towel is 46%.

A hand-feel test is done by the following process: first, after the padding process, the treated fabric or textile is conditioned for 6 hours at a temperature of 35° C. and Relative Humidity (RH) 60. The conditioned fabric is transferred to a temperature of 25° C. at RH 50.

Five panelists are fixed, and it is made sure that they have grease free hands. The fabric is then folded two times at the same face side. The hand feel is performed by horizontally rubbing the folded fabric along the surface of the fabric and averaging the score by each panelist.

The blotchiness test with 2, 5 and 10 ppm available chlorine water is done to test the color fastness. A cloth is tied in a hoop/ring and then held 45° with respect to the horizontal surface, then a burette is placed 10 cm above the cloth surface so that the fluid drop from burette can fall on the surface of the cloth. 50 ml of 2 ppm chlorine water is dropped dropwise from the burette for 1 hour, after that the fabric is dried and checked for appearance. From the observation it is noted down in Table 1 for the respective treated fabric and captured as “yes” or “no” for 10 ppm of chlorine water fastness.

The hydrophilic silicone polymer according to the present invention is also suitable to use it as a conditioning agent for hair or skin, and also for using it as antifoam in anionic base detergent composition and also as wetting agent in different industrial applications.

The details of the invention, its nature and objects are explained hereunder in greater detail in relation to the following non-limiting examples.

### EXAMPLES

The following non-limiting steps were followed in the process of preparing the inventive composition:

1) Synthesis of H-Polymer:

Fluid Wacker H polymer-55 (917 g, 0.458 moles of Si—H) having a viscosity of 60 mPa·s at 25° C. and hydrogen content of 0.05% by weight and D4 (2083 g) are transferred in glass-lined reactor. Reaction temperature is set at 85° C. under stirring. Whole reaction is performed under N₂ atmosphere (no N₂ purging). After material temperature reached to 85° C., 0.3 g PNCl₂ (100%) is added very slowly and carefully. Material temperature found to increase by 2-5° C. After complete addition of catalyst, reaction temperature is set to 92° C. (It should not reach beyond 95° C.). The reaction is continued under stirring for 4 hours at 92° C. Then material is cool down to 55° C. and neutralize with anhydrous. Na₂CO₃ powder under slow stirring for 2 h. Residue is filtered out and collected the clear, transparent fluid. The resultant structure of the fluid is: H(CH₃)₂SiO((CH₃)₂SiO)ᵤ((CH₃)HSiO)ₙSi(CH₃)₂H.

Similarly, different fluids are prepared where u is from 10 to 250 by changing the D4 quantity in the reaction and determining the value of u from the NMR data, preferably u of value 55, 80, 140, 160 and n of value is 0 to 50, is prepared by the similar synthesis process.

[Note: H-Polymer contains D chain from 10 to 250 units. Actual D chain length used is 55, 80, 140, 160 units and n=0]

2) Synthesis of Epoxy Functionalized Silicone (by Allyl Glycidyl Ether) (for Comparative Example 1 in Table 1):

H Polymer-160 (2730 g) is loaded in the reaction vessel and temperature is set to 105° C. under N₂ purging under stirring. When material temperature reaches 95° C., cyclohexene oxide and 0.3 g Pt-catalyst solution is added. 51 g of Allyl Glycidyl ether (AGE) is added into the reaction vessel through dosing with dose rate 2.5 ml/min. When dosing is completed, add 0.2 g of Pt-catalyst solution in the reaction vessel at same condition and stir for another 1.5 h. After that again 7 g AGE is added in to the reaction vessel through dosing with dose rate 2.5 ml/min. When dosing is completed, add 0.2 g of Pt-catalyst solution in the reaction vessel at same condition and stir for another 1 h. Then H-concentration is measured by NMR analysis and additional 4 g AGE (if needed) is added via dosing at same rate. Again 0.2 g of Pt-catalyst solution is added in the reaction mixture at same condition and stir for another 2 h. Reaction status is checked via NMR analysis and catalyst is added if required. Continue reaction until Si—H content is nil or <2 ppm. Cool down the reaction fluid and collect the light brown clear oil. In Table 1, The moles of epoxy groups and D units are mentioned in average value that are obtained from NMR data.

3) Synthesis of Epoxy Functionalized Silicone (by Allyl Polyether Glycidyl Ether) (for Inventive Example):

H Polymer-55 (2730 g, 1.3 moles of Si—H) having a viscosity of 60 mPa·s at 25° C. and hydrogen content of 0.05% by weight, is loaded in the reaction vessel and temperature is set to 105° C. under N₂ purging under stirring. When material temperature reaches 95° C., cyclohexene oxide and 0.3 g Pt-catalyst solution is added. Add 605 g of Allyl polyether Glycidyl ether (APGE) having 8 EO groups (1.3 moles of olefinic group) into the reaction vessel through dosing with dose rate 2.5 ml/min. When dosing is completed, add 0.2 g of Pt-catalyst solution in the reaction vessel at same condition and stir for another 1.5 h. After that again 7 g APGE having 8 EO groups is added in to the reaction vessel through dosing with dose rate 2.5 ml/min. When dosing is completed, add 0.2 g of Pt-catalyst solution in the reaction vessel at same condition and stir for another 1 h. Then H-concentration is measured by NMR analysis and additional 4 g APGE (if needed) is added via dosing at same rate. Again 0.2 g of Pt-catalyst solution is added in the reaction mixture at same condition and stir for another 2 h. Reaction status is checked via NMR analysis and catalyst is added if required. Continue reaction until Si—H content is nil or <2 ppm. Cool down the reaction fluid and collect the light brown clear oil to obtain polyoxyalkylene epoxy functional siloxane fluid. [Note: HYSI reaction has been done with allyl polyether glycidyl ether, Allyl-(EO)ₓ—(PO)_{y}-epoxy (x=5-20; y=0-4) with different H-M-Dₙ-M-H (n=50-200) siloxanes. Reaction temp range 80° C. to 120° C.]

4) Synthesis of Hydrophilic Silicone Polymer Fluid (Silicone Quaternary Fluid):

As described in Table 1, polyoxyalkylene epoxy functional siloxane fluid (intermediate epoxy silicone), amine compound, and acid is dissolved in appropriate solvent and temperature set to the reaction temperature in degree Celsius (° C.) under slow N₂ purging. Reaction is continued for 5 h, reaction mixture gets clear after some time. Check NMR of the mixture to monitor reaction progress. If reaction is found completed [>98%] then product is cool down at room temperature and collect. The final fluid structures are confirmed by NMR.

5) Characterization of Hydrophilic Silicone Polymer Fluid:

(Characterization of Example 10 Fluid of Table 1)

Chemical Structure:

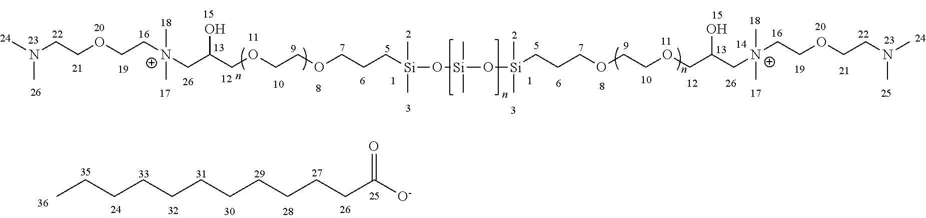

Characterization of the Polymer: ¹H NMR (CDCl3, 400 MHz): δ (ppm) 0.3-0.5 (m, 2H₅), 4.2-4.55 (m, 1H₁₃), 3.14-3.25 (d, 6H_{17,18}), 2.09-2.18 (d, 6H_{24,25}), 1.94-2.09 (t, 2H₂₆).

¹³C/APT (CDCl3, 100 MHz) δ (ppm) 13.86 (—CH₂CH₂Si), 63 (—OCH2(CHOH)CH2N⁺ (CH3)₂), 53.6-52.6 (—OCH2(CHOH)CH2N⁺ (CH3)₂), 45.5 (—OCH2CH2N(CH3)₂), 38.59 (—CH2CH2(C═O)O⁻).

²⁹Si NMR (CDCl3, 79.5 MHz): δ (ppm) −23-−21.3 (sum of Me2SiO2/2=D), −12 (ROMe2SiO1/2=DOR), 7.46 (Me₃SiO_{1,2}=M*).

N⁺ (CH₃)₂ (H_{17,18}) of cationic Si polymer and CH2COO⁻ (H₂₆) of anionic lauric acid ratio and N⁺ (CH₃)₂ (H_{17,18}) with N(CH₃)₂ (H_{24,25}) in mole % is ˜1:1

(Characterization of Example 13 Fluid of Table 1)

Chemical Structure:

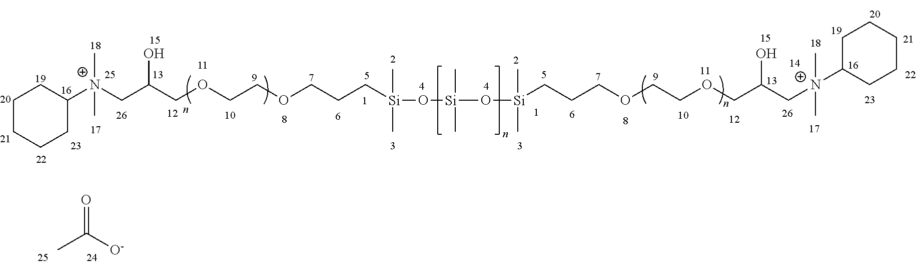

Characterization of the Polymer: ¹H NMR (CDCl3, 400 MHz): δ (ppm) 0.3-0.5 (m, 2H₅), 4.4-4.64 (m, 1H₁₃), 3.0-3.20 (s, 6H_{17,18}), 3.52 (m, 1H₁₆) 1.90-1.93 (s, 3H₂₅).

¹³C/APT (CDCl3, 100 MHz) δ (ppm) 13.07 (—CH2CH2Si), 62.1-62.7 (—OCH2(CHOH)CH2N⁺ (CH3)2), 48.0-48.6 (—OCH2(CHOH)CH2N⁺ (CH3)₂), 72.23 (—OCH2(CHOH)CH2N⁺ (CH3)₂)—CH-Cyclohexane) 24.44 (—CH3(C═O)O⁻).

²⁹Si NMR (CDCl3, 79.5 MHz): δ (ppm) −23-−21.3 (sum of Me2SiO2/2=D), −12, −13-−13.52, −15-−15.42 (ROMe2SiO1/2=DOR), 7.39 (Me3SiO1/2=M*).

N⁺ (CH3)2 (H_{17,18}) of cationic Si polymer and CH3CCO⁻ (H₂₅) of anionic acetic acid ratio and in mole % is ˜1:1.

(Characterization of Example 17 Fluid of Table 1)

Chemical Structure:

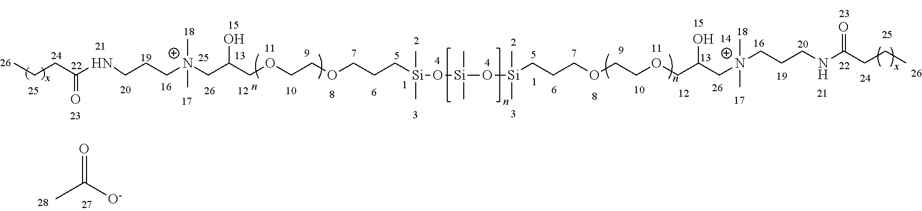

Characterization of the Polymer: ¹H NMR (CDCl3, 400 MHz): δ (ppm) 0.3-0.5 (m, 2H₅), 4.2-4.55 (m, 1H₁₃), 3.14-3.25 (d, 6H_{17,18}), 1.84-1.90 (s, 3H₂₈).

¹³C/APT (CDCl3, 100 MHz) δ (ppm) 13.98 (—CH2CH2Si), 62.73 (—OCH2(CHOH)CH2N⁺ (CH3)2), 52.16-52.7 (—OCH2(CHOH)CH2N⁺ (CH3)₂), 24.44 (—CH3(C═O)O⁻).

²⁹Si NMR (CDCl3, 79.5 MHz): δ (ppm) −23-−21.3 (sum of Me2SiO2/2=D), −12, −13-−13.52, −15-−15.42 (ROMe2SiO1/2=DOR), 7.39 (Me3SiO1/2=M*).

N⁺ (CH3)2 (H_{17,18}) of cationic Si polymer and CH3COO⁻ (H₂₈) of anionic acetic acid ratio and in mole % is ˜1:1.

Preparation of emulsion: 20% active silicone polymer emulsions were prepared by taking the polymer (base fluid) from Table 1, in the blender as per the following recipe. Acetic acid and suitable emulsifier (if any required) are added & mixed for 10 mins. Water was added gradually in steps with continuous stirring to get homogeneous translucent to clear emulsion.

| Ingredient | Qty in % |
|---|---|
| Polymer (with 20% solvent, butyl glycol) | 25 |
| Glacial acetic acid and suitable emulsifier | 0.4 |
| Demineralized water | Rest |

6) Application on Fabric/Textile/Towel:

Padding with 30 gpl of the 20% active emulsion as per above recipe. Dried in Stentor at 130° C. for 2 mins & then tumbled for 30 mins.

After application step, the treated fabric/textile/towel is analysed by the test methods as described in the description and its properties are reported in Table 1 for the corresponding composition of Example 1 to 20.

TABLE 1
Hydrophilic silicone polymer, emulsion composition and its properties

| | | | | | | | Color |
|---|---|---|---|---|---|---|---|
| | | | | | | | fastness |
| | | Base fluid | Amine | | Hand- | Water retention | in 10 |
| | | (having moles | (having | | feel by | on towel | ppm |
| Example | | of epoxy | moles of | | panel | ASTM D 4772- | chlorine |
| No. | Description | group) | amine group) | Acid | test | 97 (re 2004) | water |
| 1 | Not | Epoxy-D₁₆₀- | Jeffamine D2000 | | 8 | 10 | yes |
| | Inventive | Epoxy (0.0525 | (0.0530 mole) | | | | |
| | | mole of epoxy | | | | | |
| | | groups) | | | | | |
| | | Here, D = | | | | | |
| | | —(OSi(CH₃)₂)— | | | | | |
| 2 | Not | Epoxy-D160- | Me2N—CH2—CH2—OH | Lauric | 6 | 25 | yes |
| | Inventive | epoxy | (0.0219 mole) | acid | | | |
| | | (0.0219 mole) | | (0.0219 | | | |
| | | | | mole) | | | |
| 3 | Not | Epoxy-D140- | Bis-(2- | Lauric | 9 | 15 | no |
| | inventive | epoxy | dimethylamin | acid | | | |
| | | (0.02445 mole) | oethyl) ether | (0.02445 | | | |
| | | | (Jeffcat ZF-22) | mole | | | |
| | | | (0.02445 mole) | | | | |
| 4 | Not | Epoxy-D140- | Jeffcat ZF-22 | Acetic | 9 | 17 | no |
| | Inventive | epoxy | (0.02445 mole) | acid | | | |
| | | (0.02445 mole) | | (0.02445 | | | |
| | | | | mole | | | |
| 5 | Not | Epoxy-D80- | Me2N—CH2—CH2—OH | Lauric | 6 | 40 | yes |
| | Inventive | epoxy | (0.04275 mole) | acid | | | |
| | | (0.04275 mole) | | (0.04275 | | | |
| | | | | mole | | | |
| 6 | Not | Epoxy-D180- | Me2N—CH2—CH2—OH | Lauric | 7 | 22 | yes |
| | inventive | epoxy | (0.0179 mole) | acid | | | |
| | | (0.0179 mole) | | (0.0179 | | | |
| | | | | mole) | | | |
| 7 | Not | Epoxy-D80- | Me2N—CH2—CH2—OH | Lauric | 6 | 40 | yes |
| | Inventive | epoxy | (0.039 mole) | acid | | | |
| | | (0.039 mole) | | (0.039 | | | |
| | | | | mole | | | |
| 8 | Not | Epoxy-D80- | Jeffcat ZF-22 | Lauric | 9 | 26 | no |
| | inventive | epoxy | (0.039 mole) | acid | | | |
| | | (0.039 mole) | | (0.039 | | | |
| | | | | mole | | | |
| 9 | Not | Epoxy-D80- | Jeffcat ZF-22 | Lauric | 7 | 35 | no |
| | inventive | epoxy with 2 | (0.039 mole) | acid | | | |
| | | pendent (alkyl | | (0.039 | | | |
| | | EO8) | | mole) | | | |
| | | (0.039 mole) | | | | | |
| 10a. | Inventive | Epoxy-(EO)8- | Jeffcat ZF-22 | Lauric | 9 | 42 | yes |
| | | D55-(EO)8- | (0.0681 mole) | acid | | | |
| | | epoxy | | (0.0681 | | | |
| | | (0.0681 mole) | | mole | | | |
| 10b. | Inventive | Epoxy-(EO)8- | Jeffcat ZF-22 | Acetic | 9 | 49 | yes |
| | | D55-(EO)8- | (0.0681 mole) | acid | | | |
| | | epoxy | | (0.1362 | | | |
| | | (0.0681 mole) | | mole | | | |
| 11 | Not | Epoxy-(EO)8- | Jeffamine ED600 | | 8 | 30 | yes |
| | Inventive | D55-(EO)8- | (0.0454 mole) | | | | |
| | | epoxy | | | | | |
| | | (0.0454 mole) | | | | | |
| 12 | Inventive | Epoxy-(EO)8- | Me2N—CH2—CH2—OH | Lauric | 5 | 44 | yes |
| | | D55-(EO)8- | (0.0423 mole) | acid | | | |
| | | epoxy | | (0.0423 | | | |
| | | (0.0423 mole) | | mole) | | | |
| 13 | Inventive | Epoxy-(EO)8- | Me2N-cyclohexyl | Lauric | 7 | 44 | yes |
| | | D55-(EO)8- | (0.0462 mole) | acid | | | |
| | | epoxy | | (0.0462 | | | |
| | | (0.0462 mole) | | mole) | | | |
| 14 | Inventive | Epoxy-(EO)8- | Jeffcat ZF-22 | Lauric | 9 | 36 | no |
| | | D95-(EO)8- | (0.015 mole) | acid | | | |
| | | epoxy | | (0.015 | | | |
| | | (0.015 mole) | | mole) | | | |
| 15 | Inventive | Epoxy-(EO)8- | Me2N-cyclohexyl | Lauric | 7 | 42 | yes |
| | | D95-(EO)8- | (0.015 mole) | acid | | | |
| | | epoxy | | (0.015 | | | |
| | | (0.015 mole) | | mole) | | | |
| 16 | Inventive | Epoxy-(EO)8- | Me2N-cyclohexyl | Acetic | 7 | 42 | yes |
| | | D95-(EO)8- | (0.015 mole) | acid | | | |
| | | epoxy | | (0.015 | | | |
| | | (0.015 mole) | | mole) | | | |
| 17 | Inventive | Epoxy-(EO)8- | Me2N—(CH2)3—NH—CO—R | Acetic | 9 | 42 | yes |
| | | D95-(EO)8- | (R = Coco, (0.015 mole) | acid | | | |
| | | epoxy | | (0.015 | | | |
| | | (0.015 mole) | | mole) | | | |
| 18 | Inventive | Epoxy-(EO)8- | Me2N—(CH2)3—NH—CO—R | Acetic | 8 | 41 | yes |
| | | D95-(E0)8- | (R = Stearyl, (0.015 mole) | acid | | | |
| | | epoxy | | (0.015 | | | |
| | | (0.015 mole) | | mole) | | | |
| 19 | Inventive | Epoxy-(EO)8- | Me2N—(CH2)3—NH—CO—R | Acetic | 8 | 42 | Yes |
| | | D95-(EO)8- | (R = Lauryl, (0.0273 mole) | acid | | | |
| | | epoxy | | (0.0273 | | | |
| | | (0.0273 mole) | | mole) | | | |
| 20 | Not | Epoxy-(EO)8- | Me2N—(CH2)3—NH—CO—R | Acetic | 5 | 41 | yes |
| | Inventive | D95-(EO)8- | (R = Coco, (0.0075 mole) | acid | | | |
| | (according to | epoxy | | (0.015 | | | |
| | US2008261473) | (0.015 mole) | | mole) | | | |

We find that as in Table 1, according to the examples 10a, 10b, 12, 13, 14, 15, 16, 17, 18, and 19, the inventive composition having the silicone structure (I) is having very good hand-feel and very good water retention on towel ASTM D 4772-97 (almost equal to the water retention value of 46% of the untreated towel), along with an unexpected and surprising effect of colour fastness on towel for 10 ppm chlorine water.

1. A silicone polymer having structure (I)
XABA′X′ (I)
wherein, B is a siloxane hydrophobic part comprising (OSi(R)(R′))ₓ group,
A and A′ are hydrophilic part comprising (CH₂)_{z}(OR′)_{y}G group, and
X and X′ are ionic group attached with the hydrophilic part,
R and R′ are same or different and are a hydrogen atom or a C₁ to C₁₀ alkyl group, or a C₁ to C₁₀ substituted alkyl group,
G is —R⁶(OR²)_{f}—O—R⁵CH(OH)—CH₂—,
R¹, R² is same or different and is a linear or branched C₁ to C₆ alkylene radical,
R⁵, R⁶ is same or different and is a linear or branched C₁ to C₆ alkylene radical or a cyclic C₃ to C₈ alkylene radical,
x is from 20 to 500, y is from 5 to 30, z is from 1 to 20 and f is from 0 to 30.

2. The silicone polymer as claimed in claim 1, wherein the ionic group of the silicone having structure (I) is a cationic group.

3. The silicone polymer as claimed in claim 2, wherein the cationic group having a structure (II)
—N⁺Z_{3-w}(R³—(OR⁴)_{g}—NZ¹ₕ)_{w} (II)
wherein, Z is a hydrogen atom or a C₁ to C₁₀ alkyl group, or a C₁ to C₁₀ substituted alkyl group, or a C₁ to C₁₀ alkyl group with terminal or branched hydroxyl group, or from C₃ to C₁₀ cyclic alkyl group, or any other group that has the positive electron donating effect on the lone pair of adjacent nitrogen atom,
Z¹ is Z or carbonyl or carboxyl or amide group, or any other group that has the electron withdrawing effect on the lone pair of adjacent nitrogen atom,
R⁴ is same or different and is a C₁ to C₁₀ alkylene radical,
R³ is same or different and is a C₁ to C₁₀ alkylene radical,
g is 0 or an integer from 1 to 70, w is 0 or an integer from 1 to 3, h is an integer 2 or 3.

4. A process for preparing the silicone having structure (I) as claimed in claim 1 comprising:
(i) reacting in a first step a hydrogen siloxane of the formula
HR′₂SiO(R₂SiO)ₙ(RHSiO)ₙSiR′₂H (IV),
wherein R and R′ are same or different and are a hydrogen atom or a C₁ to C₁₀ alkyl group, or a C₁ to C₁₀ substituted alkyl group,
u is an integer from 1 to 500, n is 0 or an integer from 1 to 50,
with, an olefinic unsaturated polyoxyalkylene epoxy compound of the formula
CH₂═CH—R⁶—(OR²)_{y}—O—R⁵—CH(O)CH₂ (V),
wherein, R² is same or different and is a linear or branched C₁ to C₆ alkylene radical, in one of the embodiments C₂ and C₃ alkylene radical,
R⁵, R⁶ is same or different and is a linear or branched C₁ to C₆ alkylene radical or a cyclic C₃ to C₈ alkylene radical, y is from 1 to 30, and
in the presence of a catalyst comprising platinum or its compounds or complexes to form a polyoxyalkylene epoxy functional siloxane;
with the provision that the olefinic unsaturated polyoxyalkylene epoxy compound is used in an amount of from 0.8 to 1 mol, of the olefinic unsaturated radical (C═C) in the epoxy compound per 1 mol Si-bonded hydrogen in the hydrogen siloxane and optionally the olefinic unsaturated polyether is used in an amount of from 0 to 0.2 mol, of the olefinic unsaturated radical (C═C) in the polyether per 1 mol Si-bonded hydrogen in the hydrogen siloxane,
(ii) reacting in a second step the resulting polyoxyalkylene epoxy functional siloxane obtained from the first step with an amine compound of the formula (III)
NZ_{3-w}(R³—(OR⁴)_{g}—NZ¹ₕ)_{w} (III)
wherein, Z is a hydrogen atom or a C₁ to C₁₀ alkyl group, or a C₁ to C₁₀ substituted alkyl group, or a C₁ to C₁₀ alkyl group with terminal or branched hydroxyl group, or from C₃ to C₁₀ cyclic alkyl group, or any other group that has the positive electron donating effect on the lone pair of adjacent nitrogen atom,
Z¹ is Z or carbonyl or carboxyl or amide group, or any other group that has the electron withdrawing effect on the lone pair of adjacent nitrogen atom,
R⁴ is same or different and is a C₁ to C₁₀ alkylene radical,
R³ is same or different and is a C₁ to C₁₀ alkylene radical, g is 0 or an integer from 1 to 70, w is 0 or an integer from 1 to 3, h is an integer 2 or 3,
with the provision that the amine compound is used in an amount of more than 1 mol of amino group in the amine compound per 1 mol epoxy group in the polyoxyalkylene epoxy functional siloxane, to obtain the silicone polymer having structure (I).

5. A composition comprising a silicone polymer as claimed in claim 1.

6. A composition comprising a silicone polymer prepared by the process as claimed in claim 4.

7. An aqueous composition comprising a silicone polymer as claimed in claim 1.

8. An aqueous composition comprising a silicone polymer prepared by the process of claim 4.

9. An aqueous composition as claimed in claim 7, wherein the composition is an aqueous emulsion.

10. A process for treating organic fibers with an aqueous composition comprising treating the fibers with a silicone polymer of claim 1.

11. The process for treating organic fibers as claimed in claim 10, wherein the aqueous composition is an aqueous emulsion.

12. The process for treating organic fibers as claimed in claim 10, wherein the hydrophilicity, water-retention, blotchiness and softness of the organic fibers is improved relative to untreated organic fibers.

13. The process for treating organic fibers as claimed in claim 10, wherein the organic fiber is in the form of a textile fabric.
